(19) United States
(12) Patent Application Publication
(10) Pub. No.: US 2016/0356402 A1
(43) Pub. Date: Dec. 8, 2016

(54) Faucet Mounting Sleeve

(71) Applicant: WCM Industries, Inc., Colorado Springs, CO (US)

(72) Inventor: William T. BALL, Colorado Springs, CO (US)

(21) Appl. No.: 14/731,088

(22) Filed: Jun. 4, 2015

(51) Int. Cl. F16L 5/00; E03C 1/02

(52) U.S. Cl. CPC F16L 5/00; E03C 1/02

(57) ABSTRACT

A system for mounting a faucet assembly to the exterior portion of a dwelling is provided. A mounting sleeve is employed that is associated with a tube of a faucet assembly that is generally positioned outside of a dwelling. The tube is rigidly interconnected to a mounting sleeve that is supported by a bracket that allows for selective adjustments. That is, the mounting sleeve may be selectively offset from the interior surface of the dwelling, thereby accommodating exterior building surfaces with irregular shapes such as stone, brick, mortar, stucco, etc. The mounting system provides additional rigidity to the faucet assembly/dwelling interconnection.

This application is related to U.S. patent application Ser. No. 14/078,780, Nov. 13, 2013, which claims the benefit of U.S. Provisional Application No. 60/726,144, filed Nov. 14, 2012. The entire disclosure of which is incorporated by reference herein.

This application is also related to U.S. patent application Ser. No. 12/649,800, now U.S. Pat. No. 8,281,800, filed Dec. 20, 2009, which is a continuation of U.S. patent application Ser. No. 12/115,223, now U.S. Pat. No. 8,151,821, filed May 31, 2012, which claims the benefit of U.S. Provisional Patent Application Ser. No. 60/947,902, filed Jul. 3, 2007, the entire disclosures of which are incorporated by reference herein.

### FIELD OF THE INVENTION

Embodiments of the present invention are generally related to devices for securing faucets, wall hydrants, or other fluid delivery devices, to a building surface. One embodiment of the present invention is directed to a mounting assembly that secures a wall faucet to an uneven building surface.

### BACKGROUND OF THE INVENTION

Wall faucets are often found mounted to the exterior of a dwelling. Wall faucets include a flange designed to interconnect to an exterior dwelling surface. The wall faucet also includes a fluid delivery tube interconnected to the dwelling's water source on one end and to a valve-controlled hose bib at the other end. Traditionally, flanges are directly mounted to the exterior building surface, e.g., siding, which may provide a strong and stable interface for the wall faucet flange. Siding, however, is not the only common exterior building surface employed. For example, often wall faucets must be interconnected to stone, brick, mortar, stucco, etc., which is difficult to interconnect to, and which may not provide a sound wall faucet interconnection.

Commonly, a plurality of elongated screws are used to interconnect the faucet flange to a mounting surface, which is acceptable if the faucet flange is abutted to the mounting surface. If, however, the faucet flange must be spaced from the mounting surface, because, for example, a stone exterior surface is present, longer screws must be used to reach the interior surface. This mounting method results in an unstable wall faucet as loads are reacted some distance from the connection point. One of ordinary skill in the art can envision that a hose interconnected to the wall faucet is subject to forces generated by moving or pulling the hose. Over time, these forces will weaken the interconnection of the faucet to the dwelling and may cause the faucet flange to dislocate from the exterior building surface. If a faucet assembly should separate from the dwelling, water, insects, or other outdoor contaminants can enter the dwelling. The wall faucet could also separate from the fluid supply line, thereby causing water/mold damage. To address these issues, grout, mortar, or other formable substances are used to secure the fluid tube and faucet flange to the exterior building surface. This additional work increases the time and cost of installation, and is a temporary fix.

Devices in the prior art have been used to offset a faucet flange from an interior building surface to accommodate a brick exterior. For example, the hose bib supporter of PerfectSett made by JCT Innovations, LLC includes a rectangular shaped face offset from a plate interconnected to the outer surface of the wall, board, or sheathing of a building. The face provides a location for interconnection of a faucet assembly. One drawback of the PerfectSett device is it does not provide selective adjustments and only accommodates exterior building surfaces of a predetermined and consistent thickness.

Thus it is a long felt need in the field of outdoor plumbing to provide a stable interconnection scheme for attaching wall faucets to the exterior surface of a dwelling. The following disclosure describes an improved system and method for interconnecting a wall faucet to an exterior building surface that addresses and overcomes the problems of the prior art.

### SUMMARY OF THE INVENTION

Some aspects of the various embodiments of the present invention described herein can generally be categorized as improvements or modifications to the inventions described in the U.S. Patent Application Publication No. 2014/0131545, which is the publication of U.S. patent application Ser. No. 14/078,780. That is, the concepts discussed herein can be used with the inventions and concepts described in U.S. Patent Application Publication No. 2014/0131545.

It is one aspect of embodiments of the present invention to provide a wall faucet support. One embodiment of the present invention employs a mounting sleeve associated with a fluid tube of the wall faucet. The mounting sleeve is interconnected to a supporting bracket that interconnects to an interior building surface, thereby increasing wall faucet stability. The mounting sleeve secures the fluid delivery tube and provides a location for interconnection of a faucet flange by way of a sleeve flange. Some embodiments of the present invention employ a selectively adjustable mounting sleeve such that the faucet flange may be selectively spaced from the outer surface of the dwelling and not interconnected directly to it. Other embodiments contemplate a fixed distance between the sleeve flange and the bracket, which is ideal for accommodating exterior building surfaces with consistent thicknesses, e.g., brick.

It is another aspect of some embodiments of the present invention to provide a system for interconnecting a wall faucet to a building that increases mount stability. More specifically, embodiments of the present invention employ a bracket interconnected to an interior (or exterior) building surface. For example, the bracket of the invention may be interconnected to the inside or outside of any building member, such as 2×4 studs, sill plates, a concrete basement wall, a foundation member, headers, sheathing, etc. Interconnecting a bracket to a structural element improves the stability of the faucet assembly. That is, as opposed to prior art systems that interconnect a the faucet flange directly to an exterior building surface, the mounting sleeve employed in various embodiments of the present invention is maintained within a bracket, thus supplying a sufficient support to the faucet assembly. In such a manner the above-identified issues related to interconnecting a faucet to mortar, rock, stone, bricks, stucco, etc., are reduced if not eliminated. The method and associated apparatus of embodiments of the present invention for securing a tube within mounting sleeve, which is then interconnected to a rigidly interconnected bracket, is superior over prior art methods and systems of interconnection.

It is another aspect of some embodiments of the present invention to provide a mounting system that allows for ease of faucet installation. More specifically, embodiments of the present invention may be installed before or after the siding or other exterior building surface is installed. The bracket that secures the mounting sleeve may be installed by the framers, siding installers, or plumbers. Guess work as to the location of the faucet is reduced. This aspect of the present invention is made possible because the faucet need not be initially installed to install the bracket and to locate the mounting sleeve. After installation of the mounting sleeve, it may be removed from the bracket and associated with the faucet tube and flange and interconnected to the bracket.

It is still yet another aspect of embodiments of the present invention to provide a mounting system and method that provides the ability to selectively adjust the location of the faucet. More specifically, embodiments of the present invention provide a mounting sleeve adapted to move in relation to a fixed bracket. This aspect of the invention ultimately allows for the flange of the faucet to be offset (in various dimensions, but particularly along an axis perpendicular from the dwelling wall) from an interior or exterior wall of the dwelling to accommodate the thickness and surface texture of exterior building material such as stone, etc. In operation, if the faucet is not located as envisioned relative to the exterior building surface, readjustments are possible that do not require extensive structural modifications as would be necessary with prior art systems.

It is another aspect of embodiments of the present invention to provide a faucet assembly attachment scheme that improves mounting options, wherein the faucet may be interconnected to an irregular surface easily. That is, as briefly described above; the mounting device of one embodiment includes an adjustable mounting sleeve that allows for selective adjustments of the location of the faucet flange, e.g., within a predetermined scope of dimensions from a first anticipated final position. Thus an installer can easily customize the location of the flange such that it is aesthetically pleasing and structurally stable. Embodiments of the present invention also employ a mounting sleeve with a measurement indication mechanism. Preferably, a linear scale is provided associated with each sleeve, e.g., imprinted thereon, molded thereto, etc., to facilitate the installation of a plurality of faucets about the exterior of a building. After one mounting sleeve is interconnected and correctly offset from a house, the remainder of mounting sleeves will be more quickly installed because the required offset is readily known by inspection of the linear scale. Installers will also be able to facilitate installation of mounting sleeves through experience by knowing generally how much offset should be used for a particular building surface, which will reduce time and cost of installing faucets.

Embodiments of the present invention employ components that can be easily replaced. For example, if after installing the mounting sleeve relative to the bracket it is found the offset is incorrect, quick adjustments may be made. More specifically, it is contemplated that the length of the mounting sleeve can easily made to accommodate unique sizes of bricks, stone, etc. If this is difficult due, for example, to debris or grout residing in the grooves of the mounting sleeve, it can be discarded and a second replacement mounting sleeve can be interconnected to the existing bracket.

It is yet another aspect of embodiments of the present invention to prevent water, debris, animals, insects, etc. from entering the dwelling through the faucet connection. That is, when a faucet of the prior art becomes loose or disconnects from the exterior of the dwelling, gaps form that allow the above-mentioned foreign objects to enter the dwelling. For example, gaps between the flange and the building surface allow moisture to penetrate between the faucet flange and the exterior building surfaces. Embodiments of the present invention provide a system and method that minimizes gaps between the external building surface and the faucet associated thereto. More specifically, as the mounting sleeve of embodiments of the present invention is of generally continuous shape (preferably cylindrical, but other shapes are contemplated), the installer can finish, with insulation, foam, mortar etc., up to the outer surface of the mounting sleeve, which reduces or eliminates gaps between the faucet assembly and the exterior building surfaces. A related aspect of the present invention is that the shape of the mounting sleeve and described finishing creates a cleaner appearance that is more aesthetically pleasing.

It is another aspect of the present invention that the embodiments described herein are constructed of common materials, such as plastic, steel, aluminum, rubber (or other flexible materials), vulcanized rubber, wood, or any other common building materials that comply with applicable building codes. Preferably, the mounting sleeve and associated bracket are made of rigid plastic, which is non-corrosive and provides the needed rigidity to secure the faucet assembly.

It is still yet another aspect of the present invention to provide a system that utilizes components that are customizable. More specifically, the mounting sleeves of embodiments of the present invention may be made of any color of plastic to blend in with the exterior building surface or wall faucet assembly, thereby adding to the aesthetically pleasing appearance of the finished assembly.

It is another aspect of embodiments of the present invention to provide a mounting sleeve that can accommodate faucets having flanges of various shapes. More specifically, some faucets possess a handle laterally offset from the faucet outlet whereby access to the handle is improved. To further increase access and to remove obstructions between the faucet and the faucet outlet, the outlet may be angled as well such that the flow of water from the faucet outlet is at an angle relative to the vertical direction. Faucets of this type also may include an elliptical or oval handle that allows the user to more easily grip and turn the handle. Thus, one embodiment of the present invention includes a flange interconnected to the mounting sleeve adapted to receive faucet flanges that are other than circular. More specifically, the faucets described above, often have an elongated flange to accommodate an enlarged housing wherein the faucet outlet and handle are interconnected thereto. One can appreciate that a mounting sleeve having a mounting sleeve having a circular flange would not adequately accommodate this enlarged flange, thus embodiments of the present invention include an enlarged flange of any shape that is customizable to a faucet flange. It is a related aspect of the invention to provide a generic faucet flange that accommodates more than one type, make or model of faucet. Alternatively, one of skill in the art will appreciate that the faucet flange may be customized to fit only a specific faucet.

It is another aspect of embodiments of the present invention to provide a wall faucet interconnection device, comprising: a mounting sleeve having a first end with a mounting flange and a second end, the mounting sleeve having a plurality of grooves positioned at least about a portion of an outer surface thereof; a bracket having a boss extending therefrom that interconnects with said mounting sleeve, said boss having a selectively deflectable tab that includes an end for selective engagement into a groove of said plurality of grooves; a locking ring that selectively interconnects to said boss, said locking ring restricting movement of said deflectable tab; and a seal with an inner portion that is adapted to interconnect to a fluid tube of the wall faucet to said mounting sleeve, and an outer portion that receives a clamp that compresses said seal about the fluid tube.

It is still yet another aspect of embodiments of the present invention to provide a faucet assembly mounting device, comprising: a mounting sleeve having a first end with a means for supporting a faucet and a second end; a bracket having a boss extending therefrom that selectively interconnects to said mounting sleeve, said boss having a member for selective engagement with said mounting sleeve; and a locking device operatively interconnected to said boss, said locking device restricting movement of said member.

It is another aspect of embodiments of the present invention to provide a wall faucet mounting system, comprising: a tube that includes a plurality of first locking members; a mounting bracket having a rear surface and an opening that extends through said mounting bracket; a bracket tube extending from said rear surface of said mounting bracket, wherein said bracket tube is in communication with said opening in said mounting bracket such that said tube is slidingly disposed within said mounting bracket, wherein said bracket tube comprises a first resilient member comprising a second locking member configured to releasably engage a respective one of said plurality of first locking members; and a locking device disposed about said bracket tube that restricts movement of said second locking members.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is an exploded perspective view of one embodiment of the present invention;

FIG. 2 is a perspective view showing the mounting sleeve one embodiment of the present invention interconnected to a wall; and

FIG. 3 is a partial side cross-sectional view showing one embodiment of the present invention interconnected to a wall.

To assist in the understanding of the present invention the following list of components and associated numbering found in the drawings is provided herein:

| # | Component |
|---|---|
| 2 | Mounting sleeve |
| 6 | Building surface |
| 10 | Bracket |
| 14 | Tab |
| 18 | Groove |
| 22 | Locking ring |
| 26 | Seal |
| 30 | Fluid tube |
| 34 | Wall faucet |
| 38 | Mounting sleeve Inner Diameter |
| 42 | Faucet flange |
| 46 | Mounting flange |
| 50 | Hole |
| 54 | Offset indicator |
| 58 | Hole |
| 60 | Fastener |
| 61 | Outer surface |
| 62 | Interior building surface |
| 66 | Boss |
| 70 | Flange |
| 74 | Inner boss surface |
| 78 | Slot |
| 82 | Clamp |
| 84 | Fluid supply interface |
| 88 | Inner seal portion |
| 92 | Outer seal portion |
| 96 | Seal inner diameter |
| 98 | Outer diameter |
| 106 | Groove |

It should be understood that the drawings are not necessarily to scale, but that relative dimensions can be nevertheless be determined thereby. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

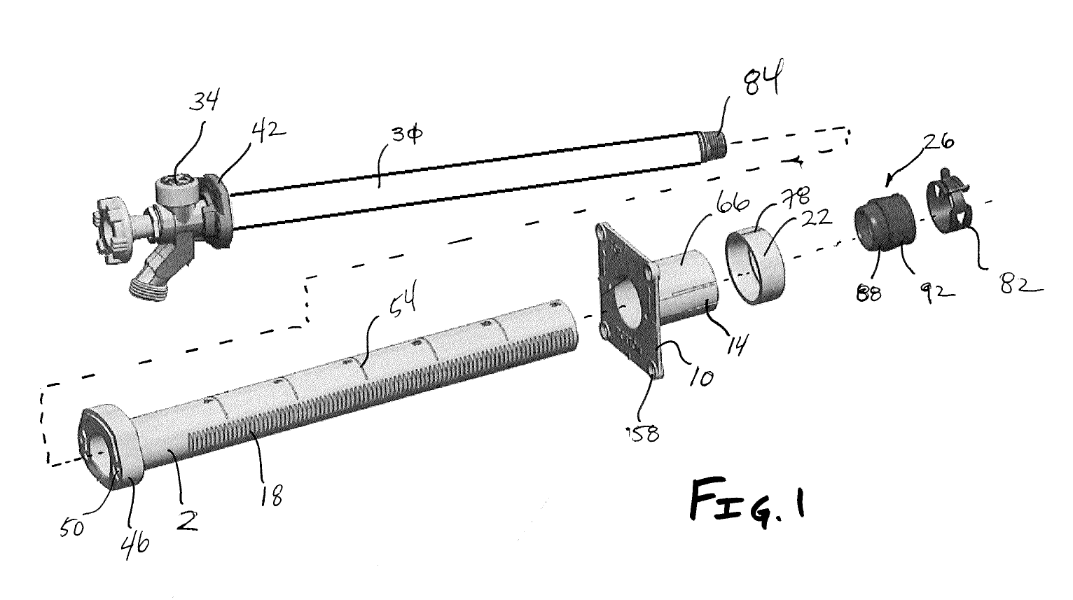

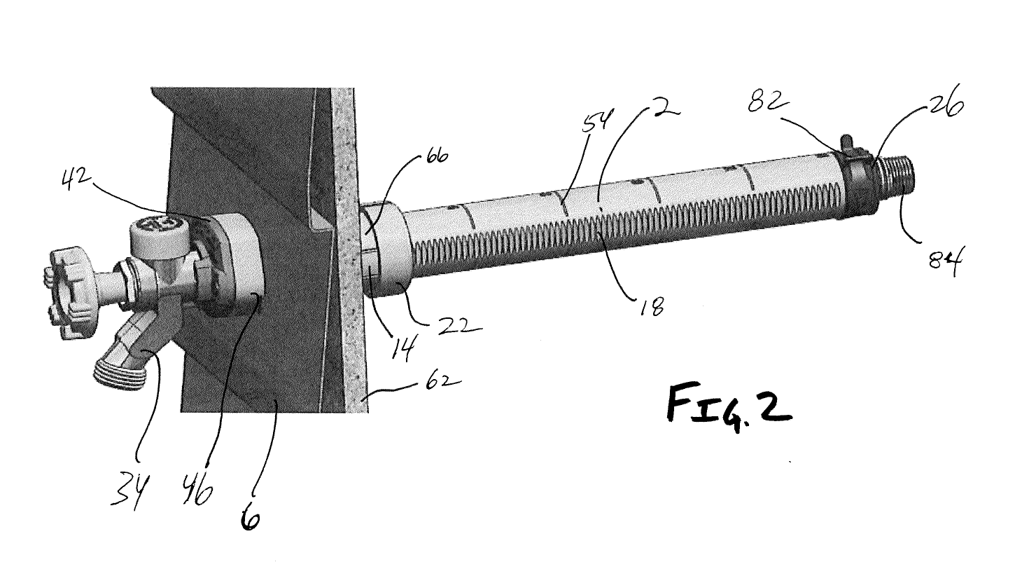

FIGS. 1-3 show the mounting sleeve 2 of one embodiment of the present invention and the components used to interconnect the mounting sleeve 2 to a building surface 6. The mounting sleeve 2 selectively interconnects to a bracket 10. The bracket 10 includes at least one tab 14 for selective engagement with a groove 18 or grooves in the mounting sleeve 2, which fixes the mounting sleeve 2 to the bracket 10. The mounting sleeve 2 is further secured to the bracket 10 by providing a locking ring 22 that prevents the tabs 14 from disengaging from the grooves 18, which would allow the mounting sleeve 2 to slide freely relative to the bracket 10. A seal 26 is used to interconnect a fluid tube 30 associated with a wall faucet 34 to the inner diameter 38 of the mounting sleeve 2, which secures the wall faucet 34 to the mounting sleeve 2. A faucet flange 42 of the wall faucet 34 is also interconnected to a mounting flange 46 of the mounting sleeve 2.

The mounting sleeve 2 includes a mounting flange 46 at its first end adapted to interface with the faucet flange 42 associated with the wall faucet 34. Accordingly, the mounting flange 46 includes a plurality of holes 50 or nut plates to receive fasteners (not shown) normally used to secure the faucet flange 42 to a wall, for example. Further, the mounting sleeve 2 includes offset 54 indicators that allow individuals to assess the distance between the mounting flange 46 and the bracket 10. In this fashion, the mounting flange 46 is offset from the bracket 10 to accommodate the exterior building surfaces 6, such as siding, stone, or brick. The mounting sleeve 2 may be hollow. Alternatively, the mounting sleeve 2 may include a plurality of inner walls or other structures that may engage the wall faucet fluid tube 30 to increase tube stability relative to the mounting sleeve 2.

The bracket 10 includes a plurality of holes 58 that receive fasteners 60 that interconnect the bracket 10 to an interior building surface 62. The bracket 10 of one embodiment of the present invention includes an outwardly-extending boss 66 with the operatively interconnected tabs 14. Tabs 14 may have inwardly extending projections that selectively engage the grooves 18 of the mounting sleeve 2, which secures the mounting sleeve 2 to the bracket 10. Although the wall mounting sleeve 2 is shown to extend generally perpendicular from the bracket 10, one of ordinary skill in the art will appreciate that the mounting sleeve may be angled relative to the bracket so the associated fluid tube 30 is tilted a predetermined amount to ensure that fluid leaks from the wall faucet 34 when it is shut off.

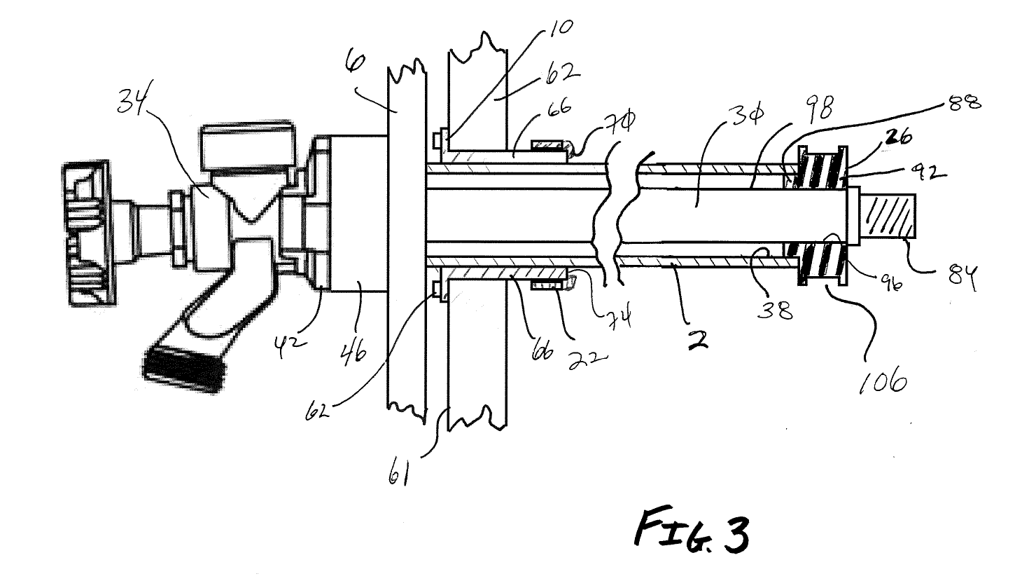

As the tabs 14 may disengage from the mounting sleeve grooves 18, some prior art systems employ a glue to interconnect the tab 14 to the mounting sleeve 2, e.g., fix the mounting sleeve 2 to the bracket 10. One improvement to the prior art system employed by some embodiments of the present invention is the locking ring 22. In operation, the locking ring 22 is positioned over the mounting sleeve 6 and the boss 66 and is situated over the tabs 14 so they cannot deflect outwardly, which would remove the tab ends from the groove 18. The locking ring 22 may include a flange 70 that abuts an inner boss surface (see FIG. 3) to prevent the locking ring 22 from sliding too far up the boss 66 to a position adjacent to the bracket, which could allow the tabs to be removed from the grooves 18. The locking ring 22 may include a slot 78 to facilitate expansion of the locking ring 22, and allow the locking ring 22 to slide over the boss 66. Those of ordinary skill in the art will appreciate that a clamp 82, e.g. c-clamp or band, may be used to ensure engagement of the tabs to the grooves instead of the locking ring.

As described above, the mounting flange 46 is designed to receive and secure the faucet flange 42 that secures the wall faucet and the fluid supply tube 30. To ensure a tight interconnection between the faucet tube 30 and the mounting sleeve 2, the end adjacent to a fluid supply interface 84 of the faucet tube must also be secured. Embodiments of the present invention address this issue by providing the seal 26. The seal 26 includes an inner seal portion and an outer seal portion 92. The seal has inner diameter 96 that coincides with the outer diameter 98 of the fluid tube 30. The inner seal portion 88 has an outer diameter 100 that coincides with the mounting sleeve inner diameter 38. The outer seal portion 92 has an outer diameter equal to or greater than that of the mounting sleeve 2.

To secure the seal 26 to the mounting sleeve 2 and the fluid tube 30, a clamp 82 is provided that when interconnected about the outer seal portion 92 will deform the seal 26 about the fluid tube 30. When interconnected, the fluid tube 30 will be fixed via the inner seal portion 88 to the mounting sleeve 2, which securely fastens both sides of the fluid tube 30 to the mounting sleeve 2. The clamp 82 inner diameter may be selectively enlarged with finger pressure, for example, so that it can be received over the outer seal portion 92. When pressure is removed, the clamp 82 will retract to compress the seal 26.

FIG. 3 illustrates the connection of the mounting sleeve 2 to an interior building surface 62. In operation, an opening is created in the interior building surface 62. A corresponding opening is also created in the outer building surface 6, if needed. That is, in some situations, the outer building surface 6 is made of brick or stone, wherein the mounting flange may be integrated directly within the exterior building surface 6 and surrounded by mortar, for example. Next, the bracket boss 66 is placed within the opening in the building surface and the bracket 10 is interconnected to an outer side of the inner building surface 6 by way of the plurality of fasteners 62. Alternatively, the boss can be made to extend away from the exterior building surface and concealed by stone and mortar, for example. The mounting sleeve 2 is then positioned through the opening in the outer building surface 6 and the mounting flange 46 is positioned adjacent to the outer building surface 6, which moves the mounting sleeve 2 through the boss 66. Once the predetermined offset between the mounting flange 46 and the outer surface 61 of the internal building surface 62 is achieved, the tabs 14 will be received by grooves 18 on the mounting sleeve 2, which secures the mounting flange 46 at the predetermined offset. The locking ring 22 is then placed over the mounting sleeve 2 and the boss 66, which maintains the tabs 14 within the grooves 18. The wall faucet 34, with interconnected fluid tube 30 is then received by the mounting sleeve 2 and the faucet flange 42 is abutted to the mounting flange 46. The faucet flange is secured to the mounting flange 46 by at least one fastener 62. Finally, the seal 26 is received over the supply interface 84 and positioned about the fluid tube 30, wherein the inner seal portion 88 is placed between the mounting sleeve 2 and the fluid tube 30. The clamp (not shown) is then positioned in a clamp groove 106 of the outer seal portion 92 to secure the fluid tube 30 to the mounting sleeve 2.

If the initially set offset is incorrect, the locking ring 22 may be removed from the boss 66 as the locking ring 22 is not glued or permanently attached to the boss 66. After the locking ring 22 is removed, the mounting sleeve 2 may be selectively interconnected to the boss 66 at a different location.

One of ordinary skill in the art will appreciate that the faucet mounting flange 46 may be made of various sizes and configurations to accommodate wall faucets 34 of other designs than that shown. Alternatively, the faucet mounting flange 42 may be made to accommodate only one type of wall faucet.

The mounting sleeve 3 of some embodiments of the present invention is generally cylindrical, wherein counter from some prior art devices, a keyway or key is not employed. Thus, the mounting sleeve 2 can rotate freely within the bracket. This functionality allows the mounting sleeve to address non-ideal interconnection schemes. For example, the internal building surface to which the bracket 10 is interconnected may not be ideal (e.g., not level) wherein slight modifications to the orientation of the bracket may be required to ensure it is properly interconnected to the internal building surface 6. If this is the situation, the bracket 10 may have to be rotated to allow for interconnection to the internal building surface 6. Employing a mounting sleeve with a keyway will prevent the wall faucet to assume an ideal and aesthetically pleasing orientation when interconnected to the mounting flange. Stated differently, if a keyway is employed, the bracket must be oriented perfectly, or the mounting flange will be skewed as the mounting flange's orientation is dictated by the keyway or key. To enhance this functionality, one embodiment employs grooves that extend all, or substantially all, the way around the mounting sleeve. Such grooves will be engaged by the tabs, regardless of boss orientation.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. In addition, one skilled in the art will appreciate that aspects of other inventions may be incorporated and are added in combination to the embodiments of the present invention disclosed herein. For example, aspects of the inventions disclosed in, for example, U.S. Pat. Nos. 6,142,172 and 6,431,204, both of which being incorporated by reference herein, which concern wall faucets, may be incorporated into embodiments of the present invention.

What is claimed is:

1. A wall faucet interconnection device, comprising:
a mounting sleeve having a first end with a mounting flange and a second end, the mounting sleeve having a plurality of grooves positioned at least about a portion of an outer surface thereof;
a bracket having a boss extending therefrom that interconnects with said mounting sleeve, said boss having a selectively deflectable tab that includes an end for selective engagement into a groove of said plurality of grooves;
a locking ring that selectively interconnects to said boss, said locking ring restricting movement of said deflectable tab; and
a seal with an inner portion that is adapted to interconnect to a fluid tube of the wall faucet to said mounting sleeve, and an outer portion that receives a clamp that compresses said seal about the fluid tube.

2. The wall faucet interconnection device of claim 1, wherein said boss is oriented at an angle relative to a rear surface of said bracket.

3. The wall faucet interconnection device of claim 1, wherein said locking ring includes a slot that allows said locking ring to expand.

4. The wall faucet interconnection device of claim 1, wherein said outer seal portion includes a groove.

5. The wall faucet interconnection device of claim 1, wherein said boss is interconnected to said mounting sleeve without glue.

6. The wall faucet interconnection device of claim 1, wherein said clamp provides constant torque.

7. The wall faucet interconnection device of claim 1, wherein said plurality of grooves comprise a first set of grooves positioned on one side of said mounting sleeve and a second set of grooves positioned opposite said first set of grooves.

8. The wall faucet interconnection device of claim 1, wherein said plurality of grooves extend around the circumference of said mounting sleeve.

9. The wall faucet interconnection device of claim 1, wherein said mounting sleeve comprises a plurality of markings at predetermined increments.

10. The wall faucet interconnection device of claim 9, wherein said plurality of grooves are aligned with a respective one of said plurality of markings.

11. A faucet assembly mounting device, comprising:
a mounting sleeve having a first end with a means for supporting a faucet and a second end;
a bracket having a boss extending therefrom that selectively interconnects to said mounting sleeve, said boss having a member for selective engagement with said mounting sleeve; and
a locking device operatively interconnected to said boss, said locking device restricting movement of said member.

12. The device of claim 11, wherein said means for supporting a faucet is a flange that is adapted to secure a faucet flange of the faucet assembly.

13. The device of claim 11, wherein said boss is angled relative to the bracket.

14. The device of claim 11, wherein said locking device is a ring that fits around said boss.

15. The device of claim 11, wherein said bracket, boss, and member are interconnected to said mounting sleeve without glue.

16. The device of claim 11, wherein said mounting sleeve comprises a plurality of markings at predetermined increments of length.

17. The device of claim 11, further comprising a seal with an inner portion that is adapted to interconnect a fluid tube of the faucet assembly to said mounting sleeve and an outer portion that receives a clamp that compresses said seal about the fluid tube.

18. The device of claim 17, wherein said outer seal portion includes a groove that accommodates said clamp.

19. The device of claim 17, wherein the clamp provides constant torque.

20. The device of claim 11, wherein said mounting sleeve has a plurality of grooves that selectively receive a portion of said member to fix the position of said mounting sleeve relative to said bracket.

21. The device of claim 20, wherein said plurality of grooves are associated with a plurality of markings at predetermined increments of length provided on said mounting sleeve.

22. The device of claim 20, wherein said plurality of grooves comprise a first set of grooves positioned on one side of said mounting sleeve and a second set of grooves positioned opposite said first set of grooves.

23. The device of claim 20, wherein said plurality of grooves extend around the circumference of said mounting sleeve.

24. A wall faucet mounting system, comprising:
a tube that includes a plurality of first locking members;
a mounting bracket having a rear surface and an opening that extends through said mounting bracket;
a bracket tube extending from said rear surface of said mounting bracket, wherein said bracket tube is in communication with said opening in said mounting bracket such that said tube is slidingly disposed within said mounting bracket, wherein said bracket tube comprises a first resilient member comprising a second locking member configured to releasably engage a respective one of said plurality of first locking members; and
a locking device disposed about said bracket tube that restricts movement of said second locking members.

25. The wall faucet mounting system of claim 24, wherein said tube and said bracket tube are oval.

26. The wall faucet mounting system of claim 24, wherein said bracket tube is oriented at an angle relative to said rear surface of said bracket.

27. The wall faucet mounting system of claim 24, wherein said bracket tube is interconnected to said mounting sleeve without glue.

28. The wall faucet mounting system of claim 24, wherein said mounting sleeve comprises a plurality of markings at predetermined increments of length.

29. The wall faucet mounting system of claim 24, wherein said first locking members comprise female detents and said second locking members comprise male detents.

30. The wall faucet mounting system of claim 29, wherein said tube and said opening and said bracket tube are cylindrical, and wherein the plurality of female detents comprises grooves that extend about the circumference of said tube.

31. The wall faucet mounting system of claim 29, wherein each of said plurality of female detents comprises a notch in an exterior surface of the tube.

32. The wall faucet mounting system of claim 29, wherein said plurality of female detents comprises a first row of female detents positioned on a first side of said tube and a second row of female detents positioned on an opposite, second side of said tube.

33. The wall faucet mounting system of claim 32, wherein said male detent is a first male detent, and said bracket tube further comprises a second resilient member comprising a second male detent, wherein said first male detent is aligned with said first row of female detents on said tube, and said second male detent is aligned with said second row of female detents on said tube.
